(19) United States
(12) Patent Application Publication
(10) Pub. No.: US 2003/0200164 A1
(43) Pub. Date: Oct. 23, 2003

(54) Trust preferred security method

(76) Inventor: Dale F. Jacobs, Upper Montclair, NY (US)

Correspondence Address: Thomas A. O'Rourke, Wyatt, Gerber & O'Rourke, L.L.P., 99 Park Avenue, New York, NY, 10016, US

(21) Appl. No.: 10/128,651

(22) Filed: Apr. 19, 2002

(51) Int. Cl. G06F 17/60

(52) U.S. Cl. 705/36

(57) ABSTRACT

A method of determining information concerning a trust preferred security is disclosed. A database is accessed and from the database the user obtains the identity of one or more trust preferred securities. In addition, the user obtains the issue yield, the current yield, the yield to call, the yield to maturity, the maturity date, the call date, the call price, the issue date, the dividend amount, the x-dividend date, the record date, and the dividend pay date for a trust preferred security. Other information that may be obtained includes whether any dividends are cumulative or non cumulative, whether deferral of the dividend is permitted by the trust agreement, and whether there is a guarantee of any type on the security. The user may also ascertain the nature of the underlying security, the nature of the trust security interest, the par value of the trust preferred security, the current bid price and the current offering price. Financial information about the issuer is shown as well as the current credit rating, if any, which rating agencies have assigned to the issuer or the Trust Preferred Security.

### FIELD OF THE INVENTION

The present invention is in the field of methods and systems for identifying the relative values of trust preferred securities.

### BACKGROUND OF THE INVENTION

A Trust Preferred Security is a fixed income hybrid security that has become popular among issuers, particularly among regulated financial institutions, which are required to meet certain minimum capital adequacy standards. Trust Preferred Securities were introduced by Wall Street during 1993 and are securities that combine the features of a preferred stock with corporate bonds. One of the advantages of certain Trust Preferred Securities is the favorable tax treatment that they provide to issuers. For example, dividends paid on certain Preferred Securities are, effectively, a tax-deductible expense to the issuer. As a result, some Trust Preferred Securities have begun to replace traditional preferred stock at many financial institutions since they are a cheaper source of regulatory capital. Because of this advantage to the issuers, certain Trust Preferred Securities offer comparatively higher yields to purchasers than corporate bonds and debt instruments.

There are approximately 122 publicly traded Trust Preferred Securities issued by financial institutions in the market presently. The total market value is approximately $11.5 billion. Financial institutions have also issued Trust Preferred Securities under Rule 144A of the Securities Act of 1933 (“The Act”), as amended, and they represent an even larger market than the public market; however, they are much less liquid and reserved for qualified buyers in relatively large transaction sizes, typically $500,000 or larger.

Trust Preferred Securities typically have three parts to their structure. Initially, a bank or thrift holding company sets up a wholly owned special purpose subsidiary in the form of a grantor trust, which, by its nature, is not subject to federal or state taxation. The trust issues preferred stock, generally described as Trust Preferred Securities or Capital Securities, to the public or in a private placement. With the proceeds the trust purchases a junior subordinated debenture from the bank or thrift holding company with mirror image terms of the Trust Preferred Securities issued by the grantor trust. The bank or the thrift holding company pays interest on the junior subordinated debt to the trust and the grantor trustee then pays a like amount in dividends to the Trust Preferred Security holders. The trust agreement gives the holders of the Trust Preferred Securities a beneficial interest in the junior subordinated debt. A similar structure using a pool of mortgages instead of a junior subordinated debenture issued by a bank or thrift instead of a holding company has also been used occasionally and is sometimes called REIT Trust Preferred Securities..

According to Federal Reserve capital guidelines, the junior subordinated debentures must be subordinated to all other debt and have the longest feasible maturity in order to qualify as Tier 1 Capital for regulatory purposes. Generally accepted accounting principles provide that the inter-company loan be eliminated upon consolidation of the bank or holding company's financial statements with the Trust Preferred Securities appearing as minority interest on the consolidated balance sheet. Since the bank or holding company can deduct the interest paid on the intercompany loan and since the grantor trust is not subject to taxation, the preferred dividends are tax deductible to the issuer and, as a result, can enhance the issuer's after-tax cash flow compared to a non-deductible security.

Financial institutions in particular are drawn to Trust Preferred Securities because they provide a low cost of acquiring regulatory capital, provide debt-like characteristics for tax purposes and may be treated as Tier 1 Capital by the regulators. In order to qualify as Tier 1 Capital, the instrument must be deeply subordinated (i.e. junior subordinated), have the longest feasible maturity (i.e. 30 years or longer) and have an interest deferral right, (i.e., a provision that permits the parent company to defer interest payments on the junior subordinated debentures for a maximum of 20 consecutive quarters without causing a default). The Federal Reserve caps the amount of cumulative preferred stock including Trust Preferred Securities that a bank holding company may include in its Tier 1 Capital at 25% of total Tier 1 Capital.

The advantages of Trust Preferred Securities accrue not only to the issuing institution but also to the investor. Trust Preferred Securities are typically sold in the public market with par values of $25 or $10 per share. These prices make the securities more accessible to the average investor. Even though Trust Preferred Securities have a term of 30 years or more, many Trust Preferred Securities are traded on major exchanges rendering them easy to monitor, and more importantly, providing them with a measure of liquidity. While each of these are important factors for investor interest in the securities, they are not the most important. Non-rated Trust Preferred Securities issued by community bank and thrift holding companies are typically priced at the time of issuance to yield at least 400 basis points above the 10 year U.S. Treasury note rate.

Trust Preferred Securities issued in the private placement market under Rule 144A of the Act are structured more like a corporate bond than a preferred stock. Such securities typically have a $1,000 par value, pay dividends semi-annually, trade with accrued income and trade in minimum required sizes of 100 units ($100,000 at par).

Besides the attraction of high yield on Trust Preferred Securities, some investors also buy them in anticipation of an acquisition of the issuer by a larger, more creditworthy institution. Such an acquisition would make the Trust Preferred Securities more valuable and the share price would be likely to move up.

Trust Preferred Securities are redeemed at par upon maturity of the junior subordinated debentures issued by the holding company to the grantor trust. In addition they may be called under certain circumstances (see below) at par or a premium to par depending on the provisions of the agreement.

Trust Preferred Securities are interest rate sensitive and will decline in price if interest rates increase. Similarly, the securities may increase in value if interest rates move lower. As a result, many Trust Preferred Securities are sold with a provision that renders them non-callable for a given period of time, typically, five to seven years. After the period when the Trust Preferred Securities are not subject to call the issuer may choose to call the securities and would do so most likely if its cost of capital has declined substantially from the time when the Trust Preferred Securities were issued. Another risk that purchasers of Trust Preferred Securities have is the risk that Congress may at some future point eliminate the tax benefits to the issuer. Because of the risk that the tax-exempt status of interest expense on junior subordinated debentures may change, many issuers have a provision in the security that allows the issuer to redeem the security at par and exchange it for a comparable security should the tax benefits be altered.

The Federal Reserve has indicated that a Trust Preferred Security must have the “longest feasible maturity.” This maturity has been defined to date as a period of at least thirty years. It is possible for the Federal Reserve to set a shorter period.

As noted above, the issuer typically has the option to call the security after a period of time. In addition, the issuer can also call the security prior to maturity if at some future date, for example, the minority interest created in the transaction is not allowable as Tier 1 capital as ruled by the Federal Reserve. Another event that could result in calling the security would be if the taxing authority negatively alters the net tax burden to the bank or holding company. A calling of the security could also occur through a change in the regulation by the Securities and Exchange Commission that would render the trust an investment company by the SEC.

Dividends, also called “distributions”, are payable quarterly or semi-annually and are also cumulative. Issuers of Trust Preferred Securities can defer interest payments for up to five years without being in contractual default. This feature is of benefit to a company facing a difficult financial situation. Deferred dividend payments compound quarterly and, while not received by the investor, the investor is still taxed on the accrued, but not received deferred dividend. If the bank or holding company fails to pay the interest for more than twenty quarters, i.e., five years, the trustees could force the parent company into bankruptcy on behalf of the Trust Preferred stockholders. The payment can also be accelerated in the event of default by the parent company.

One of the characteristics of the Trust Preferred Securities market is that information about each of the issues is not available in a convenient location and no standardized, comparable data is readily available to help in the evaluation of these securities. The inventor has developed a proprietary analytical approach to gather relevant information on each of the Trust Preferred Securities in the public market, and using this approach, the inventor has created a valuable methodology for producing attractive returns from investing in Trust Preferred Securities.

### BRIEF DESCRIPTION OF THE DRAWINGS

FIG. 1 is a spread sheet showing the types of data that can be retrieved by the method of the present invention.

FIG. 2 a continuation of the columns of the spread sheet on FIG. 1.

FIG. 3 is a representative computer system which may be used in the method of the present invention.

### DETAILED DESCRIPTION OF THE INVENTION

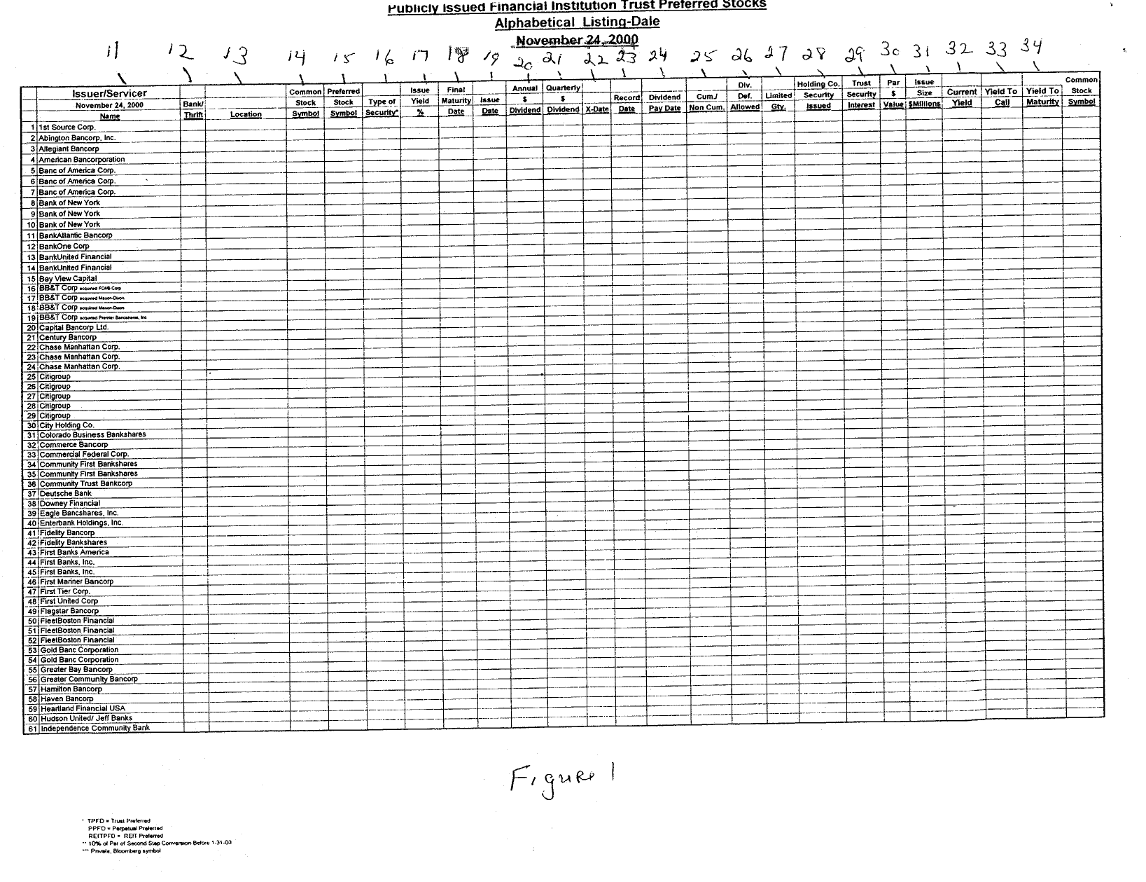

In the method of the present invention the user accesses selected databases by any suitable means including but not limited to the use of a computer system having the data stored thereon, through access to a network such as a WAN (wide area network), a LAN (local area network), the Internet, the world wide web, an intranet or other resources, to search for certain typically pre-selected, relevant information concerning one or more Trust Preferred Securities in order for the user to compare the securities and make a determination or an informed decision on the relative value of a particular security for investment purposes. As seen in FIG. 1, the information obtained may be presented in the form of a spread sheet or in any other suitable display format that are well known to those skilled in the art. Typically, the user searches for information that may be most relevant in making a decision with respect to a Trust Preferred Security. In the method of the present invention the first step is to access certain individualized information concerning a particular security. However, the order of accessing the information is not necessarily important in most instances. In addition, the search may be done whereby all the information is sought in a single search or it may be done one at a time.

Initially, there may be a search for the identity of the different Trust Preferred Securities in existence. Presently, there are one hundred and twenty-two of these securities traded on the New York or American Stock Exchanges or traded in the national over-the-counter market and quoted on the NASDAQ National Market System. For purposes of the invention, the “Issuer” of the Trust Preferred Security 11 is usually the corporate name of the issuer of the subordinated debt to the grantor trust, however, each grantor trust is technically the issuer of the Trust Preferred Security.. Whether the issuer is a bank or a thrift holding company 12 is also ascertained. The distinction between the bank trust preferred securities and the thrift trust preferred securities is mainly a credit quality issue. Other information accessed may include the geographic location 13, and their stock symbol both common 14 and preferred 15. This information is frequently important since it has been found that many of the community bank and thrift companies have very similar names and this additional information is useful to distinguish the various trust preferred securities that are in existence from each other. It also makes it easier to more quickly find information about the issuer or the security. The identity and the other information sought for these securities is obtained from a number of conventional databases as there is no one source that has this information available. In the column 16 there is also the heading type of security for those instances where more than one type of security is included in the display.

In order to make an evaluation on the value of a particular trust preferred security there are a number of considerations that may make up such a determination. Many of these factors are very subjective to each individual investor and as a result one investor may place greater weight on one factor than another or even ignore some of these factors altogether. The information accessed from the databases that are used in a determination of the value of a trust preferred security include such factors as the issue yield 17, the final maturity date 18, the issue date 19, the annual dividend 20, the quarterly dividend 21, the x-dividend date 22, the record date 23, and the dividend pay date 24. The issue yield 17 is the nominal interest rate of the security divided by the security's par value when it was issued by the issuer. This yield remains constant throughout the term of the security and does not vary. The final maturity date 18 is the latest date when the issuer can redeem the security. The maturity date is normally at least 30 years from the issue date 19, of the security.

The annual dividend 20 is the amount of the annual dividend in dollars that is paid annually to the record holder of the trust preferred security. The quarterly dividend 21 is one fourth of the annual dividend. Sometimes the dividend is paid semi-annually and that would be shown in 21 and 22. In many securities, not just trust preferred securities, there is an x-dividend date 22. On this date, whoever the owner of the security is receives the dividend when it is issued on the pay date 24. For example, if a security pays a quarterly dividend on the last day of each quarter, i.e., March 31, there is an x-dividend date established which is two business days prior to the Record Date which the issuing company announces. If the security is purchased on the x-date, the buyer will not receive the dividend since his actual ownership of the security does not occur until three days after the trade date, thus he will not be an owner on the record date. The dividend pay date 24 in FIG. 1 is frequently the initial of the particular months that the dividend is issued, e.g., M, J, S, and D for March, June, September and December. The date of payment in the month is shown as a whole number, i.e., 1 or 15 or 30, etc.

Additional information obtained from the database that may be relevant can include whether the dividends are cumulative or non cumulative 25, whether deferral of the dividend is permitted by the trust agreement 26, and whether there is a guarantee of any type on the security 27. Similarly, information is frequently obtained from the database on the nature of the underlying security 28 and the nature of the trust security interest 29. The par value of the trust preferred security 30 and the size of the issue 31 can also be pertinent in an evaluation of a trust preferred security. Information on the current yield 32, the yield to call 33, and the yield to maturity 34, can also be relevant.

Whether the dividends are cumulative refers to a situation where a trust preferred security misses or omits a security for one or more reasons, usually financial. In common stocks for example, dividends are usually non cumulative, i.e., if a company omits a dividend that dividend is lost and the company is under no obligation to make up that dividend if the company's finances turnaround. In the area of trust preferred stocks, the dividend is usually cumulative, which refers to the situation that if a preferred dividend is ever omitted the company is obligated to make up the deferred dividend before it pays common stock dividends.

Whether the dividend must be paid when due or whether a dividend that is otherwise due can be omitted is a factor in evaluating a trust preferred security. This feature is identified in FIG. 1 by the reference numeral 26. The reference to whether a guarantee is present is shown at 26. This guarantee is typically a very limited guarantee in trust preferred securities. Normally, the guarantee is merely that if there is money in the trust to pay the dividends and to redeem the securities at maturity the guarantor guarantees that the investors will be paid.

The nature of the underlying security 28 issued by the holding company identifies the principal asset of the Trust, i.e., junior subordinated debenture, etc. The nature of the trust security interest owned by the Trust Preferred shareholders29 indicates whether the ownership interest is preferred, beneficial or indirect. The par value 30 refers to the initial price of the security when it was originally issued. This amount is usually $10.00 or $25.00 for public Trust Preferred Securities or $1,000 for private placements, although the par value can be any amount. The par value is also the amount that the owner of the security will receive when the trust preferred security is redeemed at the end of its term. The size of the issue 31 designates the total value of the trust preferred securities when originally sold..

The current yield 32 is the amount of the annual dividend divided by the most recent offered price of the security. The yield to call 33 is based on the annual dividend, the discount or premium to the call price, the current “offered” price of a trust preferred security and the length of time to the call date. As the price of the underlying security varies daily or over short periods of time the yield to call will also vary. As the yield to call exceeds the issuer's cost of capital the possibility that the security may be called prior to its maturity date increases. The yield to maturity 34 is based on the annual dividend, the current “offered” price of the Trust Preferred Security, the discount or premium to the par value payable on the date of maturity of the security and the length of time to maturity.

Many investors may also seek additional information from the database in order to have as much detail as possible. Additional information that is available may include the Preferred CUSIP number 35, and the identity of the exchange 36 where the securities are traded. Some of the most important information that is sought from the databases includes the current bid price 37, the current offering price 38, the next call date 39, the number of days to the next call date 40, the call price 41, and the days to maturity 42. Also pertinent information from the data base may include the ratings of the security 43, if any, by any of the rating services. There may also be information desired concerning the financial characteristics of the issuer such as assets 44, the equity to assets ratio 45, the ratio of reserves to loans 46, the total dividend payout as a percent of net income 47, the return on assets 48, and the return on equity 49.

Once investors or potential investors have all or some of this information they can make informed decisions about a trust preferred security. Some investors may place greater weight on one factor compared to another, however, in making an investment decision. The present invention permits each investor to have all of the relevant information easily available in a format that allows for ready and meaningful comparisions.

The present invention is directed to a system and more preferably a computer network. The term computer network as used herein is used in its broadest sense i.e. as any configuration of data processing devices and software connected for information exchange. The present invention can include personal computers, personal digital assistants (PDA's), set top boxes used on or in connection with televisions, and any other type of appliance that can access a collection of data such as the Internet and visualize images.

In one embodiment the appliance can include a network that serves to connect together a plurality of devices, e.g., terminals, computers, etc. Networks typically comprise a plurality of devices such as computers some of which function as servers to provide services to the other computers connected to the network. There are many types of computer networks in existence. They are known by various names including Local Area Network (LAN), Wide Area Network (WAN), Internet and the like and may be implemented in accordance with a variety of known architectures.

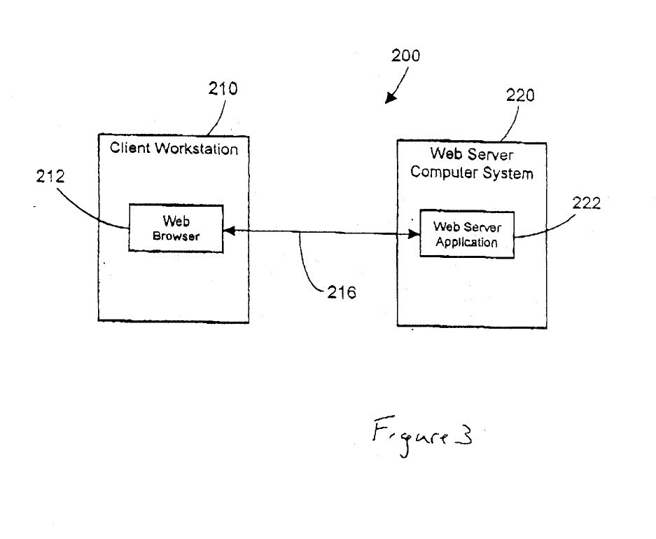

Referring to FIG. 3, in one embodiment of the invention the data concerning trust preferred securities may be accessed by using a computer system 200 and accessing the information from the Internet, the world wide web, an Intranet or other sources. In accessing the relevant information using a computer system there is preferably a transaction between a standard web browser 212 running on a client workstation 210 and a web server application 222 running on a web server computer system 220 occurring over a connection (communication link or communication mechanism) 216. The client workstation 210 may be coupled to other computer systems via a local area network (LAN) or via any other type of computer network or other interconnection. Likewise, web server computer system 220 may be coupled to other computer systems as well. Client workstation 210 may be any computer that is capable of providing access to the Internet, the world wide web, an Intranet or other sources by using web browser 212. This would include handheld, portable or laptop computers, standard desktop computer systems, dumb terminals connected to a mainframe, etc.

Web browser 212 is a software program running on client workstation 210 that allows a user at client workstation 210 to communicate with other computers over connection 216. Web browser 212 would include any web browser, which is capable of transmitting and receiving data over the Internet, the world wide web, an Intranet or other sources. This includes commercial software applications such as IBM's WebExplorer, Internet Netscape Navigator, Microsoft Explorer, Apple Computer's CyberDog, and any other software application which now exists or which may be developed in the future for accessing or processing information over the Internet, the world wide web, an Intranet or other sources. The preferred embodiment for connection 216 is any suitable communication link or communication mechanism to the Internet, including a hardwired connection, telephone access via a modem or high-speed T1 line, infrared or other wireless communications, computer network communications (whether over a wire or wireless), or any other suitable connection between computers, whether currently known or developed in the future.

It should be noted that client workstation 210 and web server computer system 220 may be the same physical and/or logical computer system. Web browser 212 typically displays pages of data including but not limited to data in the form of HTML, XML, XHTML or their future incarnations to a user at client workstation 210. Other types of data (besides HTML) may also be transmitted to web browser 212, including text data, graphical data (e.g., Graphic Image Format (GIF) files), audio data or sound files (e.g., WAV files), Java applets (executable code) and a specialized data form known as Multipurpose Internet Mail Extensions (MIME) data (which may include combinations of the foregoing and other data types).

Web server application 222 is a software program running on web server computer system 220 that allows a user at client workstation 210 to access data bases or other information controlled by web server 220. Web server computer system 220 typically outputs pages of HTML data to WEB browser 212 in response to requests by web browser 212 that reflect action taken by the user at client workstation 210. In addition, as explained above, web server computer system 220 may output other types of data to web browser 212 as well. Output data may include static HTML pages (meaning that the content of the page does not vary), or may include data that must be dynamically determined and inserted into the output data. Web server application 222 may dynamically build output data (e.g, an HTML page) from parts that it retrieves from memory within web server computer system 220 or from other computer systems, or may simply pass through a page that has been constructed at an earlier time or by another computer.

Web browser 212 typically interacts with web server application 222 by transmitting input (e.g., a Uniform Resource Locator (URL) or an HTML page) over connection 216 to web server computer system 220. This input is typically transmitted using HyperText Transfer Protocol (HTTP) 1.0. Web server computer system 220 running web server application 222 receives the input from web browser 212, and in response, outputs data (e.g., an HTML page) to browser 212. Web server computer system 220 may also have numerous other software components, including Common Gateway Interface (CGI) programs or modules, for performing desired functions. The process described above illustrates a basic transaction over the Internet, recognizing that many details and variations that are within the scope of the present invention are not disclosed herein for the purpose of providing a simple context for understanding the concepts of the present invention.

In one embodiment of the invention, information concerning trust preferred securities can be obtained using a computer system and searching the Internet, the world wide web. an Intranet or other sources for data on the trust preferred securities. However, once the appropriate databases are identified, their location may be stored on the computer system for readily updating the data as necessary. Since many of the yields discussed above for the trust preferred securities vary over time due to price fluctuations, it may be necessary to calculate the yield at any given time. This can be performed manually or can be programmed into the computer system so that once the latest price is ascertained from the database, the various yields can be calculated.

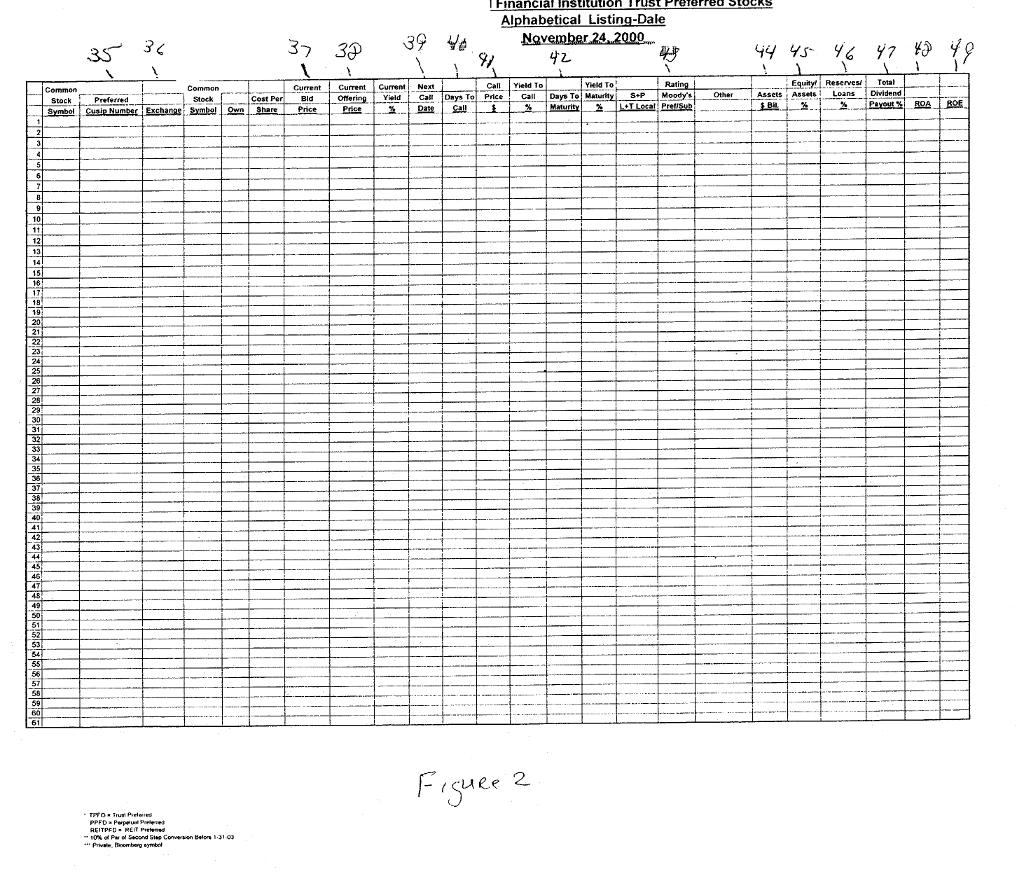

Once the data has been accessed and obtained, the data can be placed in the form of a spreadsheet of the type shown in FIGS. 1 and 2 or may be presented in another form.

I claim:

1. A method of determining information concerning a trust preferred security comprising
accessing a database and obtaining the identity of one or more trust preferred securities;
accessing one or more databases and obtaining the issue yield, the first maturity date, the issue date, the dividend amount, the x-dividend date, the record date, and the dividend pay date for a trust preferred security;
accessing one or more databases and ascertaining whether any dividends are cumulative or non cumulative, whether deferral of the dividend is permitted by the trust agreement, and whether there is a guarantee of any type on the security;
accessing one or more databases and ascertaining the nature of the underlying security, the nature of the trust security interest, the par value of the trust preferred security, the current yield, the yield to call, and the yield to maturity;
accessing one or more databases and ascertaining the current bid price, the current offering price, the next call date, and the call price.

2. The method according to claim 1 wherein the identity of the trust preferred security is its corporate name.

3. The method according to claim 2 wherein the information obtained includes the geographic location of the issuer of the trust preferred security.

4. The method according to claim 3 wherein the information obtained includes the stock symbol of the trust preferred security.

5. The method according to claim 4 wherein the information obtained includes the common stock symbol of the issuer and the preferred stock symbol of the trust preferred security.

6. The method according to claim 5 wherein the information obtained includes whether the trust preferred security is a bank trust preferred security or a thrift trust preferred security.

7. The method according to claim3 wherein the dividend information includes the annual dividend

8. The method according to claim3 wherein the dividend information includes the quarterly dividend.

9. The method according to claim 3 wherein the information obtained includes the size of the issue.

10. The method according to claim 3 wherein the information obtained includes the whether the dividend must be paid when due, and whether a guarantee is present.

11. The method according to claim 3 wherein the information obtained includes the nature of the underlying security issued by the holding company, nature of the trust security interest

12. The method according to claim 3 wherein the information obtained includes the whether the trust preferred security is a subordinated debenture or a junior subordinated debenture.

13. The method according to claim 3 wherein the information obtained includes information of whether the ownership interest is beneficial or not.

14. The method according to claim 3 wherein the information obtained includes the Preferred CUSIP number, the identity of the exchange where the securities are traded, and the common stock symbol.

15. The method according to claim 3 wherein the information obtained includes the number of days to the next call date, and the days to maturity, the ratings of the security, the assets of the companies issuing the trust preferred securities, their equity to assets ratio, the ratio of reserves to loans, the total dividend payout as a percent of net income, the return on assets, the return on equity.

16. The method according to claim 1 wherein one or more of the databases are accessed by a computer network having a web browser running on a client workstation that communicates with a web server application running on a web server computer system.
